(19) United States
(12) Patent Application Publication
(10) Pub. No.: US 2019/0079641 A1
(43) Pub. Date: Mar. 14, 2019

(54) INTELLIGENT SYSTEMS AND METHODS OF PRODUCTING DIGITAL AND NON-DIGITAL DESIGN OUTPUTS

(71) Applicant: Jamison HILL, Mesa, AZ (US)

(72) Inventor: Jamison HILL, Mesa, AZ (US)

(21) Appl. No.: 15/702,710

(22) Filed: Sep. 12, 2017

(51) Int. Cl. G06F 3/0482; G06F 17/24; G06F 17/22

(52) U.S. Cl. CPC G06F 3/0482; G06F 17/30507; G06F 17/2247; G06F 17/248

(57) ABSTRACT

Intelligent systems and methods for producing digital and non-digital design outputs. Methods and systems of and for selecting design elements using a software program, and producing a design output based at least in part on the user selections. A non-transitory computer readable storage medium storing a computer program product for producing digital and non-digital design outputs.

### FIELD OF THE INVENTION

The present inventive systems and methods relate to producing digital and non-digital design outputs. In particular, the systems and methods relate to creating design outputs using a software program. More specifically, the present inventive methods and systems relate to creating design outputs using questions and topics to produce design outputs based at least in part on values selected from the questions or topics.

### BACKGROUND OF THE INVENTION

The creation of digital and non-digital designs using software is difficult. Various technical fields, such as industrial design, architecture, fashion, interior design, communications, marketing, and the arts use software to create various digital and non-digital designs and/or design outputs. These design outputs are used in various media such as magazines, newspapers, software applications, and of course, on websites on the internet.

In particular, website design is an especially difficult and cumbersome process that involves a large amount of design creation and ingenuity. Websites are created using software code, such as HTML, CSS, JAVASCRIPT, and other programming languages. To create a website, programmers and software developers often spend countless hours coding, revising and perfecting software code to create websites. Users and companies hire computer programmers and/or website developers and often pay thousands of dollars to have even a simple website created.

In recent years, various digital tools have been developed to allow a normal user or layperson to create a website and/or design a website interface without the need for hiring a website developer. Such tools include systems provided by GoDaddy®, Wix®, Squarespace®, SiteBuilder, weebly®, web.com®, Deluxe™, BigCommerce®, WordPress® and others. These advanced tools allow users to develop their own websites without the assistance of a computer programmer or website developer.

However, all known methods and systems to produce digital and non- digital designs or design data are limited to the usability by and skills of a layperson and the resultant complexity and capability of output software program and/or software data. That is, all known interface design and building software programs for layperson use only produce rudimentary interfaces limited in complexity and capability.

Beyond only creating a rudimentary or “flat” user interface, a layperson must enlist the skills of a so-called website or interface builder or master to design and create a custom solution to solve the individual's or entity's interface problem, and thus to create the website.

Disadvantageously, however, planning and designing, coding, testing, and finalizing a software program or software data for use and execution on a hardware device is beyond the skills and capabilities of a typical layperson interface user. In fact, many times, such is beyond the skills and capabilities of most computer and software technologist, engineer, and scientist interface users, as it is difficult to create websites of even moderate complexity.

Moreover, even if a user is able to create a website using one of these programs, these existing tools and the limitations on the skills of users, fail to take into account aesthetic design elements of a website. Existing tools do not provide an adequate solution that allows users to create aesthetically pleasing websites and, thus, the existing tools, are not useful to create a professional looking website that incorporates design features. Moreover, existing tools not only lack in their ability to assist in the production of an aesthetically pleasing website design, they also do not provide guidance in ensuring said websites are usable and/or that they follow best practices of website design and architecture.

Thus, existing tools still require designer intervention from a website designer in order to create a professional looking website.

It is desired to provide a method and system to overcome the above-mentioned disadvantages in the prior art and to allow users to create aesthetically pleasing websites and software code in an efficient and practical manner.

### SUMMARY OF THE INVENTION

It is an object of the present invention to provide a method and system to overcome the above-mentioned disadvantages in the prior art.

It is an object of the present invention to provide a method and system to allow users to create aesthetically pleasing websites and software code in an efficient and practical manner.

It is an object of the present invention to provide a method and system that allows users to select options from various interface design elements to create aesthetically pleasing websites and software code.

It is an object of the present invention to provide a method and system that allows users to read and answer questions for a custom design to be generated at the end of the flow, not requiring advanced tools, understanding, technical expertise, or participation of an expert in the field.

It is an object of the present invention to provide a method and system which incorporates sound and known interface design elements and practices which guide users through a series of questions and selections related to a desired resultant interface configuration, and based at least in part upon the user responses, to generate a program or data output in accordance with the user responses.

It is an object of the present invention to provide a method and system which incorporates sound and known interface design elements and practices which guide users through a series of questions and selections related to their desired resultant interface configuration, and based at least in part upon the user responses, to generate a program or data output in real-time in accordance with the responses.

These and other objects of the invention are achieved by providing a system for creating a design output using a software program, comprising: a processor; a user interface; and software executing on the processor configured to: present to and prompt a user to provide an element value to satisfy one or more design element questions or topics; determine whether the one or more design element questions or topics are satisfied by the element value; visually display the result of the element value of a question or topic in real-time to the user on said interface; and produce a design output, wherein the design output is produced upon the satisfaction of at least one design element question or topic by the element value in a finite set of at least one questions or topics.

In certain embodiments, the design output is produced in accordance with all design element values satisfied for the design element questions or topics in the set of questions or topics.

In certain embodiments, the result of the element value of a question or topic is displayed before, during and after determining the one or more design element questions or topics are satisfied by the element value.

In certain embodiments, the one or more design element questions or topics are selected from a group consisting of: at least one visual representation within a set of visual representations; at least one option from a set of options comprised of at least one option; a file; and a text value.

In certain embodiments, based at least in part upon the user selecting at least one visual representation within the set, the software executing on the processor presents to the user a second set of at least one visual representations for selection.

In certain embodiments, the at least one question or topic is a color, a shape, a font, and image, a video and a sound, and a combination thereof.

In certain embodiments, the at least one question or topic is configured to control a mathematical function, hyperlink, executable application, or a combination thereof.

In certain embodiments, the software provides a series of questions or topics relating to color palettes, color application in a specimen, color flows, font preferences, image style preferences, icon style preferences, illustration style preferences and a combination thereof.

In certain embodiments, the design output is generated in real-time.

In certain embodiments, the interface is manipulated using a toggle control or a selector control.

In certain embodiments, the toggle control includes a right down arrow key, space bar, 4-way joystick.

In certain embodiments, the interface is hosted via a server or on a website.

In certain embodiments, the design output is code for a website.

In certain embodiments, the design output is code for an email, a mobile homepage, a pitch deck and social ad and a software dashboard, and combinations thereof.

In certain embodiments, the design output is generated based on rules using custom generated design preferences.

In certain embodiments, the design output is not based upon pre-existing templates or previously established design styles.

In certain embodiments, the system is dynamic and wherein there are different sets of element values presented to the user depending upon the previous element values selected by the user.

In certain embodiments, the design output is a software code output.

Other objects of the invention are achieved by providing a method for creating a design output using a software program, the method comprising the steps of: providing a software executing on a processor, the software performing the following steps: presenting to and prompting a user to provide an element value to satisfy one or more design element questions or topics; determining whether the one or more design element questions or topics are satisfied by the element value; visually displaying the result of the element value of a question or topic in real-time to the user before, during and after determining the one or more design element questions or topics are satisfied by the element value; and producing a design output upon the satisfaction of at least one design element question or topic by the element value in a finite set of at least one questions or topics.

In certain embodiments, the design output is a software code output.

Other objects of the invention are achieved by providing a non-transitory computer readable storage medium storing a computer program product for selecting design elements for a software program, the non-transitory computer readable storage medium comprising: computer executable instructions and data, the computer executable instructions able to execute a computer program able to: present to and prompt a user to provide an element value to satisfy one or more design element questions or topics; determine whether the one or more design element questions or topics are satisfied by the element value; visually display the result of the element value of a question or topic in real-time to the user before, during and after determining the one or more design element questions or topics are satisfied by the element value; produce a design output upon the satisfaction of at least one design element question or topic by the element value in a finite set of at least one questions or topics.

In certain embodiments, the design output is a software code output.

Other objects of the invention are achieved by providing a method of and for satisfying design element questions or topics using a software program, the method comprising the steps of: providing an executable software program which presents to and prompts a user to provide a value that will satisfy one or more design element questions or topics in at least one of the following ways: selecting at least one visual representation within a set, selecting at least one option from a set of options comprised of at least one option, submitting a file, submitting a text value; the executable software program provides a means of visually displaying the result of the potentially satisfying element value of a question or topic in real-time before and after making final the element value of a question or topic; whereby upon the satisfaction of at least one design element question or topic by the user in a finite set of at least one questions or topics, the executable software program produces a design output in accordance with all design element values satisfied by the user for the design element questions or topics.

Other objects of the invention are achieved by providing a system for selecting design elements of a software program, the system comprising: a processor; software executing on the processor, the software comprising computer executable instructions configured to: present to and prompt a user to provide a value that will satisfy one or more design element questions or topics in at least one of the following ways; selecting at least one visual representation within a set, selecting at least one option from a set of options comprised of at least one option, submitting a file, submitting a text value; the executable software program provides a means of visually displaying the result of the potentially satisfying element value of a question or topic in real-time before and after making final the element value of a question or topic; whereby upon the satisfaction of at least one design element question or topic by the user in a finite set of at least one questions or topics, the executable software program produces a design output in accordance with all design element values satisfied by the user for the design element questions or topics.

Other objects of the invention are achieved by providing a non-transitory computer readable storage medium storing a computer program product for selecting design elements for a software program, the non-transitory computer readable storage medium comprising: computer executable instructions and data, the computer executable instructions able to execute a computer program able to: present to and prompt a user to provide a value that will satisfy one or more design element questions or topics in at least one of the following ways; selecting at least one visual representation within a set, selecting at least one option from a set of options comprised of at least one option, submitting a file, submitting a text value; the executable software program provides a means of visually displaying the result of the potentially satisfying element value of a question or topic in real-time before and after making final the element value of a question or topic; whereby upon the satisfaction of at least one design element question or topic by the user in a finite set of at least one questions or topics, the executable software program produces a design output in accordance with all design element values satisfied by the user for the design element questions or topics.

Other objects of the invention involve using a spacebar or toggle feature to scroll through design elements to assist a user in creating a design output.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a schematic flowchart of one embodiment of the invention.

FIG. 2 is a schematic flowchart of a method of another embodiment of the invention.

FIGS. 3-10 are screen shots of a question flow of an embodiment of the invention.

FIGS. 11-13 are screen shots of a question flow of an embodiment of the invention.

FIG. 14 is a detailed view of the system architecture of an embodiment of the invention.

### DETAILED DESCRIPTION OF THE INVENTION

This application herein incorporates by reference co-pending application entitled “Intelligent Systems and Methods for Dynamic Color Hierarchy & Asthetic Design Computation” filed on Sep. 12, 2017 (Attorney Docket No. 07194-P0002A).

In the following description, numerous details are set forth for the purpose of explanation. However, one of ordinary skill in the art will realize that the invention may be practiced without the use of these specific details.

The present invention allows users to produce beautiful design assets with speed and ease. The present invention allows for users to generate websites, advertising artwork, digital media designs, brochures, interior designs, software interface designs, mobile application interface designs, and the like.

In the prior art, previous methods and tools required a designer, or involved designer input to develop software code. If a user wanted to design a website, for example, he or she needed to hire a web site designer for his/her services or choose a pre-existing design from a template and modify a template. Thus, designer intervention was required to produce an aesthetically pleasing web site.

The present invention provides methods and systems that uses sound design practices to guide users through questions relevant to their desired design output, and generates an output that incorporates their input, preferences and requirements in real-time.

For ease of understanding and conceptual visualization, in certain embodiments of the invention, the inventive method and system produces one or more questions or topics relevant in the production of the desired design output. The system provides a range of input types to enable a user to satisfy a question or topic. The system provides means for a user to satisfy each question or topic through a graphical user interface (GUI). The system then compiles this information and produces a design output.

In certain embodiments, the system can be applied in a variety of applications and use-cases, including stand-alone applications or as a part of an external application.

In certain embodiments, the system provides a means to communicate the steps and hierarchy of question/topic structures for a given design output to end users.

In certain embodiments, the system asks the user a question or topic. In certain embodiments, the question or topic is related to color, font and/or other core design questions.

In certain embodiments, the questions or topics assist a user in choosing design preferences for a design output, replacing copy or words for a design output, replacing digital assets for a design output, configuring external tools and resources to support the deployment of a design output, and/or arranging design output layouts.

In certain embodiments, the content, order or existence of system- generated questions or topics and their options may be influenced dynamically by previously-satisfied questions or topics.

In certain embodiments, the questions or topics guide users to producing a website or web publishable content.

In certain embodiments, the input types provided to a user include an option to continue to the next question, a multiple-choice option, a text input and/or any other input type.

In certain embodiments, the value to satisfy a question or topic provided by the system for one or more questions or topics are system-generated.

In certain embodiments, a graphical user interface (GUI) displays one or more topics or questions at a time.

In certain embodiments, the system provides users with a visual indicator of the progress made within a given sub-step or the progress in whole of generating a design output.

In certain embodiments, satisfying a question or topic automatically progresses the user to the next question or topic.

In certain embodiments, the question or topics are satisfied by the input or selection of a single option from one or more options.

In certain embodiments, the system produces a visual representation of the design output for the purpose of visualizing the context of one or more design options for a given topic or question before and after a user finalizes on an answer of the question or topic at hand.

In certain embodiments, the system produces a visual representation of the progress of the design output in real-time as users satisfy each question or topic.

In certain embodiments, a user can preview options to a question or topic using a binary toggle and select an option with a selector.

In certain embodiments, the design output produced by the system is software code, an image, a design file formatted for various software-based design applications, an animation, a file, instructions on how to design a prescribed design output, website code and/or static media content.

In certain embodiments, the design output produced by the system is a modification to an existing or previously generated design output.

In certain embodiments, the system includes various modules and software executing on processors, so that a dynamic flow is provided to a user to allow the user to create a design output.

Exemplary Flow

In certain embodiments of the invention, a user will enter a flow and the following will occur:
1. The user will be presented with a question or design topic or category. In certain embodiments, when presented with a question regarding the color of the output, the question could be phrased as “What color do you like?” in other embodiments, the question could be phrased as a category title, such as “Color”. In certain embodiments, various colors or color palettes could be presented that a user can select from without showing a question or topic. In certain embodiments, a question or category may be omitted altogether given that the interface displays the options in such a way the user can understand what the category or question would be simply by the way the options are presented to the user.
2. Depending on the question or category type, the user will either select from system generated options or will be asked to provide the system with information. The user will then see selectable options or a means to provide the system with the requested information for each question or design topic.
3. The user will select an option or provide the information requested by the system.
4. The user will repeat the question-option-input (1-3) actions until all questions in the flow are finished.

Optionally, a user might see a small representation of the final design output respond and change as the user makes selections down the flow.

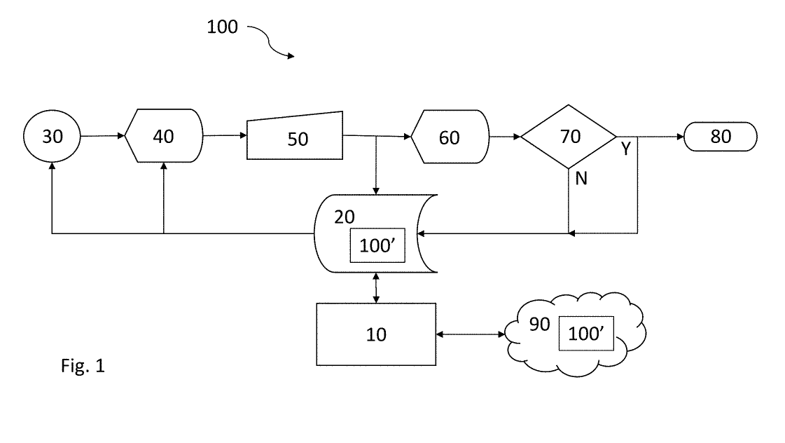

As depicted in FIG. 1, such a flow is provided. In an embodiment of the inventive method and system (100), a processor (10) executes an inventive embodiment of a non-transitory software program (100′) reposited on a local storage (20) and/or an intranet and/or the internet (90). It is contemplated that the processor (10) can execute software programs and/or software data which provides the following exemplary design flow depicted by the Figures herein.

The inventive method and system (100) initiates a design flow (30) by prompting and/or asking a user the purpose of and/or other interface design related questions (40). An initial design flow question (40) may be “What type of interface is being built?” and provide a text entry box, and/or a plurality of anticipated responses for selection (50) by a user.

The inventive method and system (100) based on the user responses and via the processor (10) determines a subsequent design flow question (60) by query of a database or rule set (not shown) reposited on a local storage (20) and/or an intranet and/or the internet (90).

It is contemplated that the method and system (100) is heuristic in that any database or rule set may be amended and/or augmented based upon selected and also non-selected user design responses (50), and by data retrieved from an intranet and/or the internet (90) data source (not shown).

It is contemplated that the inventive method and system (100) may provide and display a series of design flow questions and/or selections providing a real-time preview of the configuration of an in-process (60) and/or a final (80) designed user interface.

It is contemplated that the inventive method and system (100) may provide and display an unknown yet finite series of design flow questions and/or selections (50), and when a final design question and/or selection is provided (60), a user may be asked “Is the interface design complete?” (70) It is contemplated that in lieu of asking the user if he/she has completed the design process (70), the system (100) may recognize all design flow questions and/or selections (50) required to produce a design output have been satisfied and automatically answer Yes on behalf of the user without prompting a question to inquire if the design process is complete. If Yes, then a final user interface design software program, non-software design output, or software data is generated for storage (20, 90) and/or use (80). If No, then an in-process user interface design software program or software data is generated for storage (20, 90) and later completion and finalization (80).

It is contemplated that the inventive method and system (100) may provide a user with an interface software program and/or software data templates for use and/or customization by a user.

It is contemplated that the inventive method and system (100) may base at least in part the design flow questions and/or selections upon known and commonly used user interface design standards, guidelines, and other specifications accessed locally (20) and/or remotely (90).

It is contemplated that the processor (10) used in the inventive method and system (100) may be a single data processor or a distributed processor locally and/or remotely placed.

It is contemplated that the inventive method and system (100) non-transitory software program (100′) may be a single stand-alone program and/or data set; and/or a distributed software program and/or data set reposited and accessed locally (20) or remotely (90).

It is contemplated that the inventive method and system (100) non-transitory software program (100′) provides a preview and/or a selection of previews based at least in part upon the user input and/or selections (50).

It is contemplated that the inventive method and system (100) non-transitory software program (100′) may be a single or distributed software program or data set reposited and accessed remotely (90) with no local storage (20) before finalization (80) and/or without satisfying certain criteria such as for example entering a password and/or paying a fee.

It is contemplated that the inventive method and system (100) also includes non-transitory software program (100′) stored on a memory.

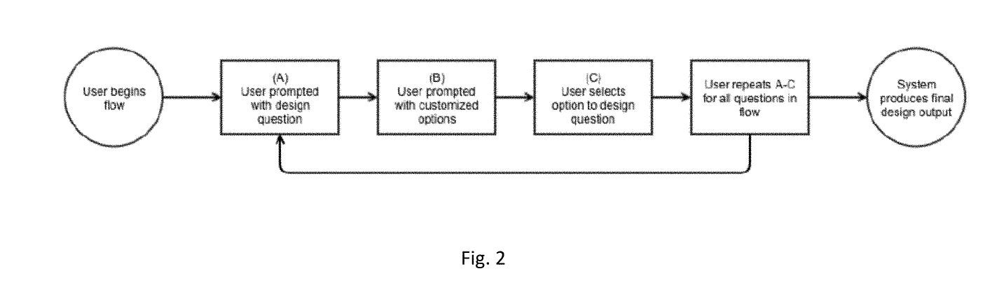

As shown in FIG. 2, a question/answer based flow is shown. In set (A), the user is prompted with a design question. In step (B) the user is presented with customized options. In step (C) the user selects an option to a design question. Afterwards, the user repeats steps (A)-(C) for all questions in the flow, and afterwards the system produces a final design output based upon the flow.

In certain embodiments, a preview of the final output is generated in real-time and made visible to the user.

In certain embodiments, the questions in the flow presented to the user include questions relating to color palettes, color applications in a specimen, color flows, font preferences, icon style preference, illustration style preferences, and the like.

In certain embodiments, the final output is generated based on rules using custom generated design preferences, not on pre-existing templates or previously established design styles foreign to the user.

In certain embodiments, the interface can be manipulated successfully guiding users through the flow using on a toggle control and selector control.

In certain embodiments, such as with step (A), the right down arrow keys are for moving between question design options and the down arrow to select the option in focus and move to the next question.

In certain embodiments, step (B) involves using a 4-way joystick where right/left motion moves the user between question/design option and the down motion selects the option in focus and moves the user to the next question.

In certain embodiments, step (C) involves using the spacebar key in combination with the enter key, where the spacebar key moves the user through the question design options and the enter key selects the option in focus and moves the user to the next design question.

In this manner, a joystick or keypad can be used with minimal effort from a user to create a design output.

Additional Question Flow

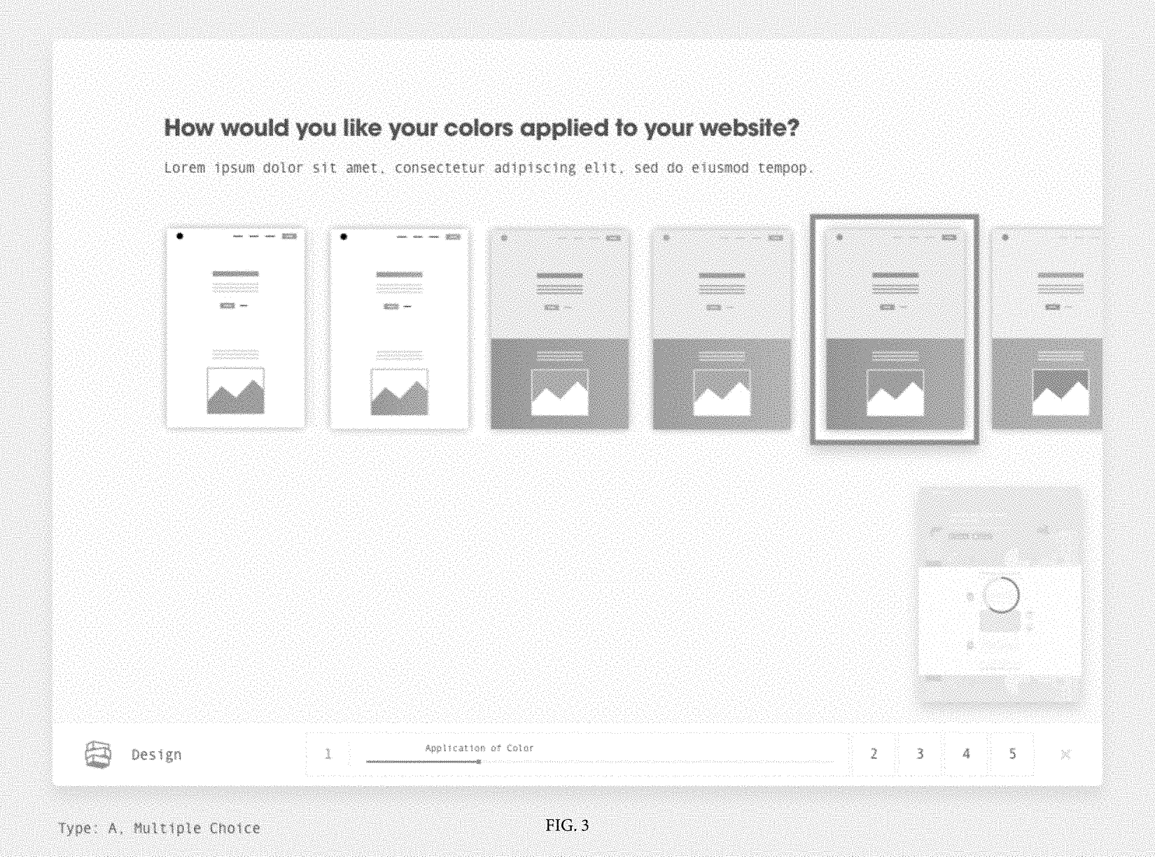

FIGS. 3-10 show various screen shots of a question flow of an embodiment of the invention. This question flow is shown as website pages; however, the question flow can be provided using a GUI, mobile device, mobile application, or other media in which a design output can be created.

FIG. 3 asks a user how the user would like colors applied to a website and provides the user with various icons to select from. This is an example of a Type A: Multiple Choice Question. In this manner, a user can pick the colors from a set of icons. In certain embodiments, the user can scroll through the icons using a joystick, or with the spacebar. Once the user finds an icon that he or she wishes to select, it can be selected via the enter key or a button on the joystick.

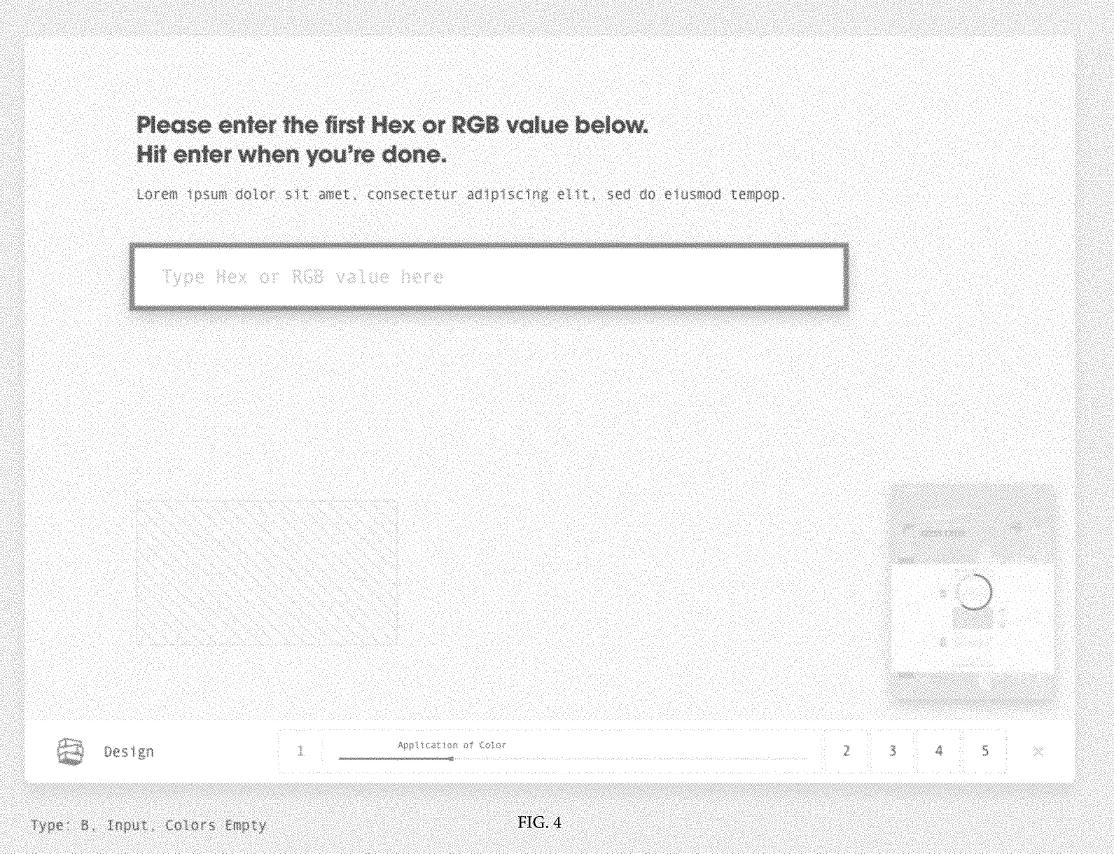

FIG. 4 asks a user to enter a first Hex or RGB value. This is an example of a Type B: Input. In this manner, the user enters a color value into the system. The color value can be a numeric value or a text value which can be converted into a Hex or RGB value.

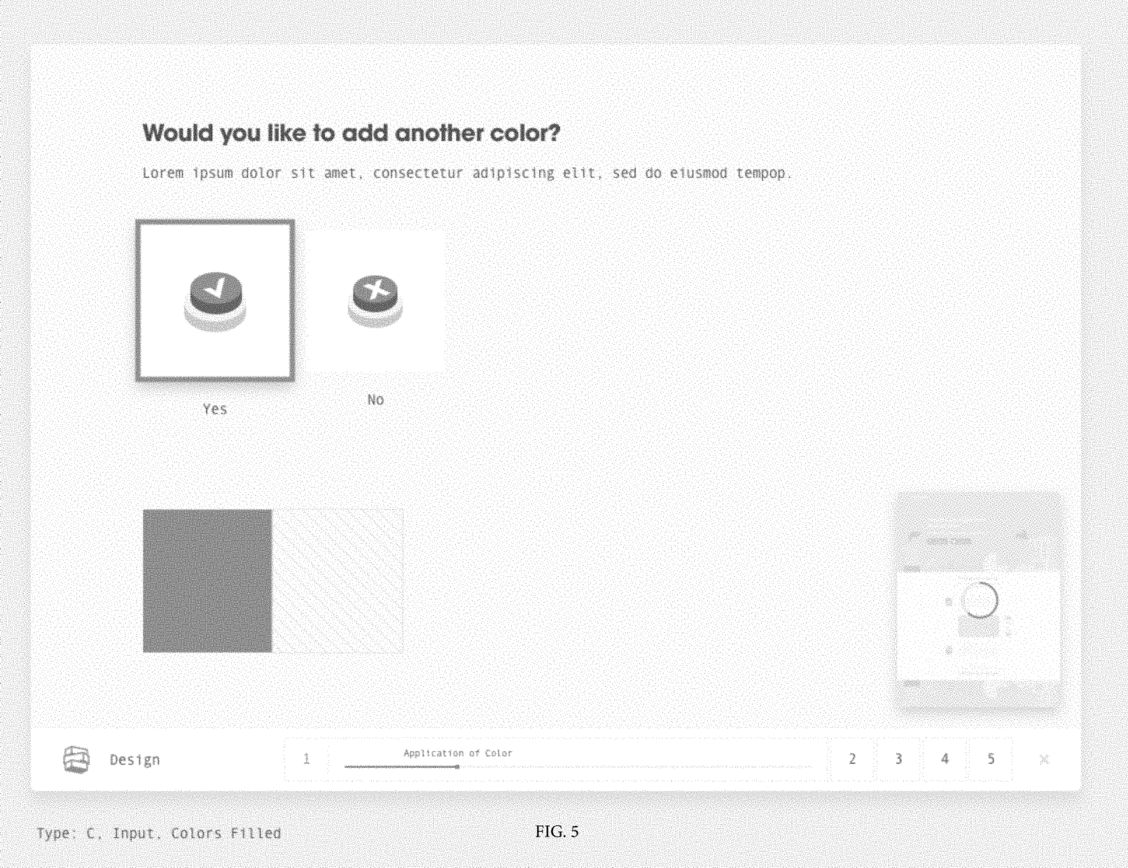

FIG. 5 is a sequential question asking whether or not the user would like to add another color to the website. In this manner, the system is dynamic and this flow question occurs after the user selects a first color via either FIG. 3 or FIG. 4.

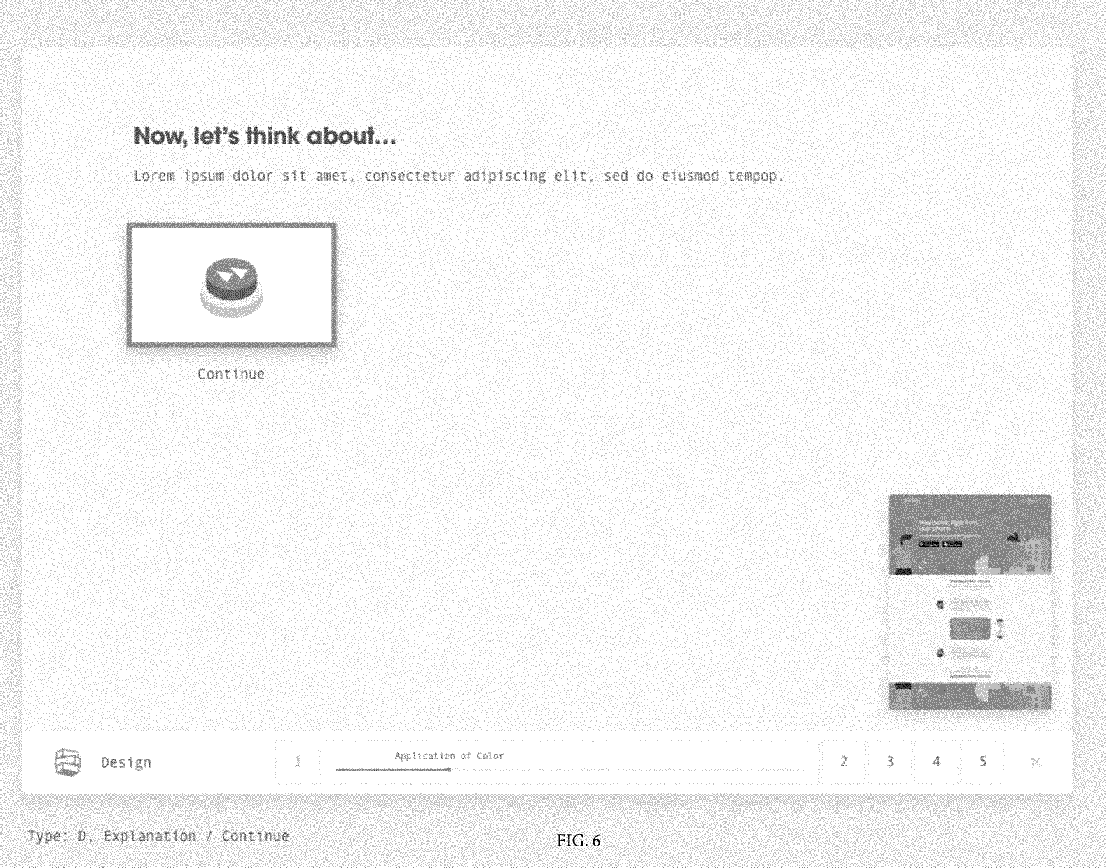

FIG. 6 is a screen that allows users to click-through to access the remaining questions in the flow. In this flow, the system gives the user a chance to evaluate the flow of the design or provide a good stoppage point to later continue building the design output.

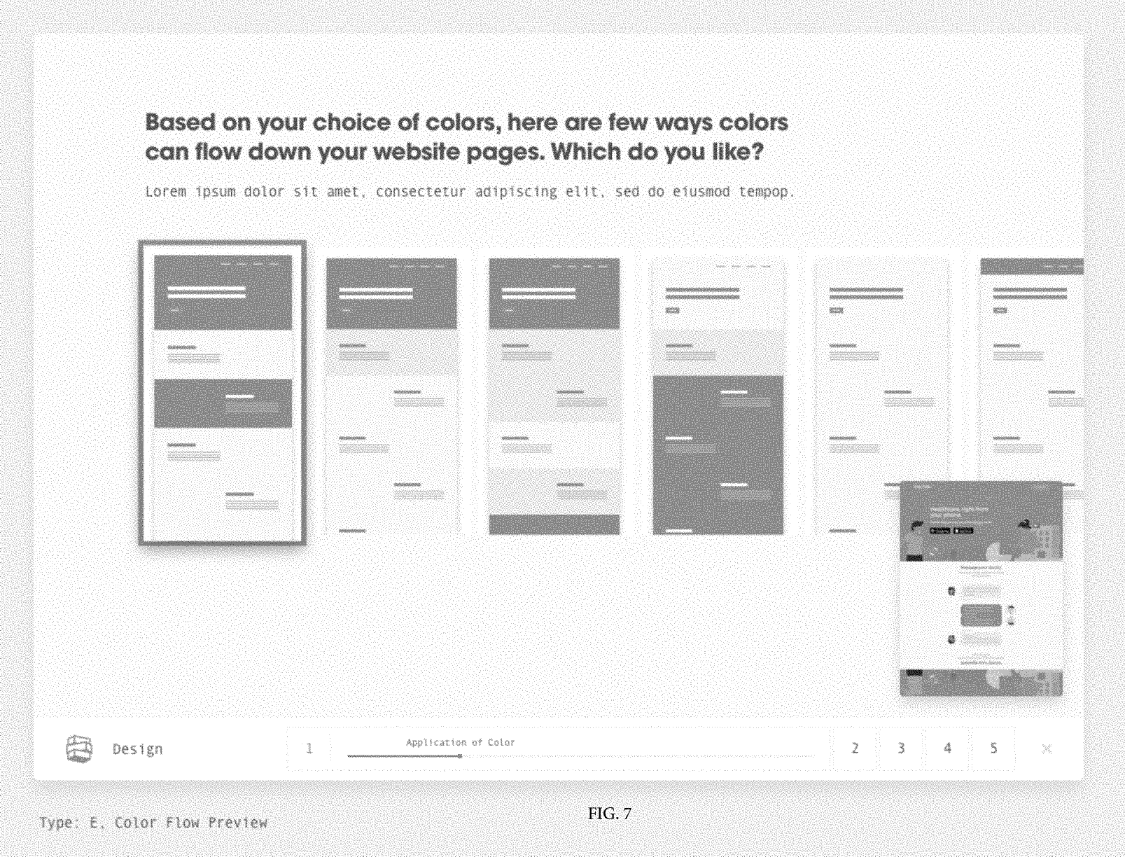

FIG. 7 asks the user additional questions about the color flow through websites and provides various options for a user to choose from. FIG. 7 provides various layouts of color on a website, which a user can select.

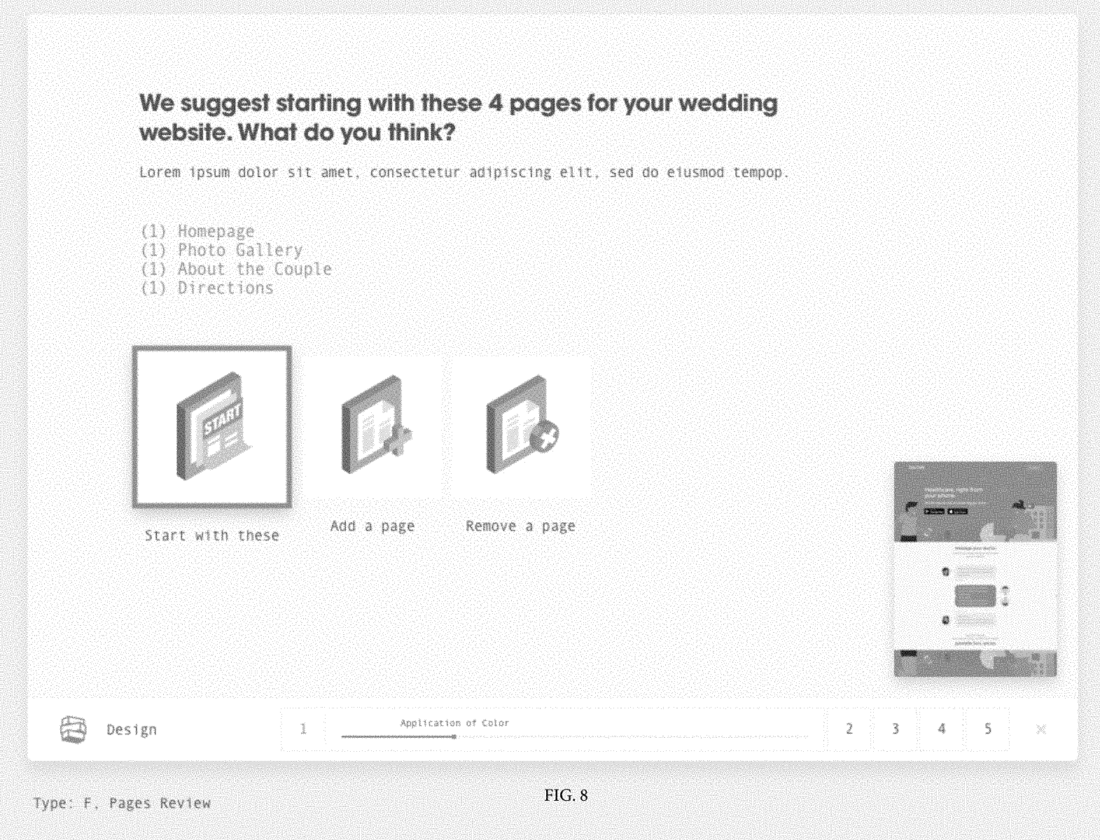

FIG. 8 provides a template whereby it is suggested to a user to have certain pages on their website. For example, in FIG. 8, a builder for a wedding website is provided suggesting a homepage, photo gallery page, about the couple page and directions page. In this page, the user can keep the standard selected webpages and can further add a page or remove a page to continue to make a customized website or design output.

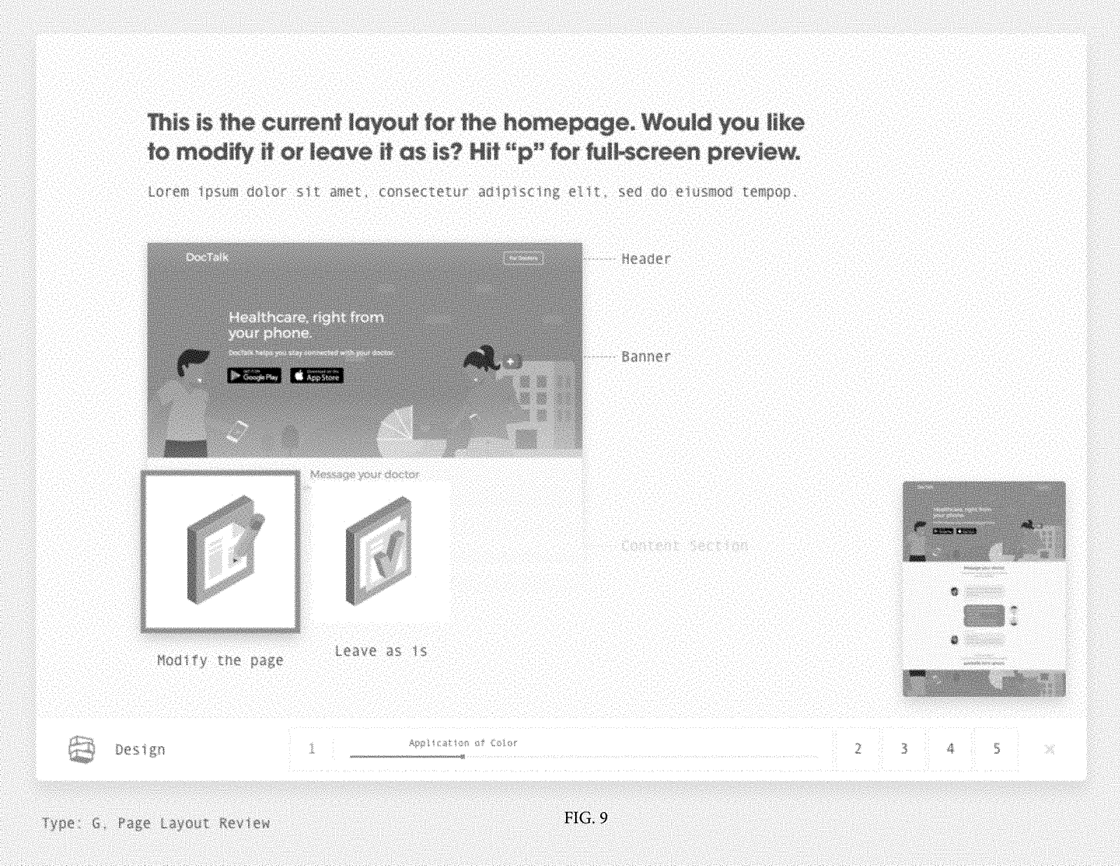

FIG. 9 asks the user a question regarding the layout of the website to modify it or leave it as is. FIG. 9 also provides the user with an option for a full- screen preview. FIG. 9 highlights the ability to modify the page and provides a user with the ability to manually modify the page if necessary.

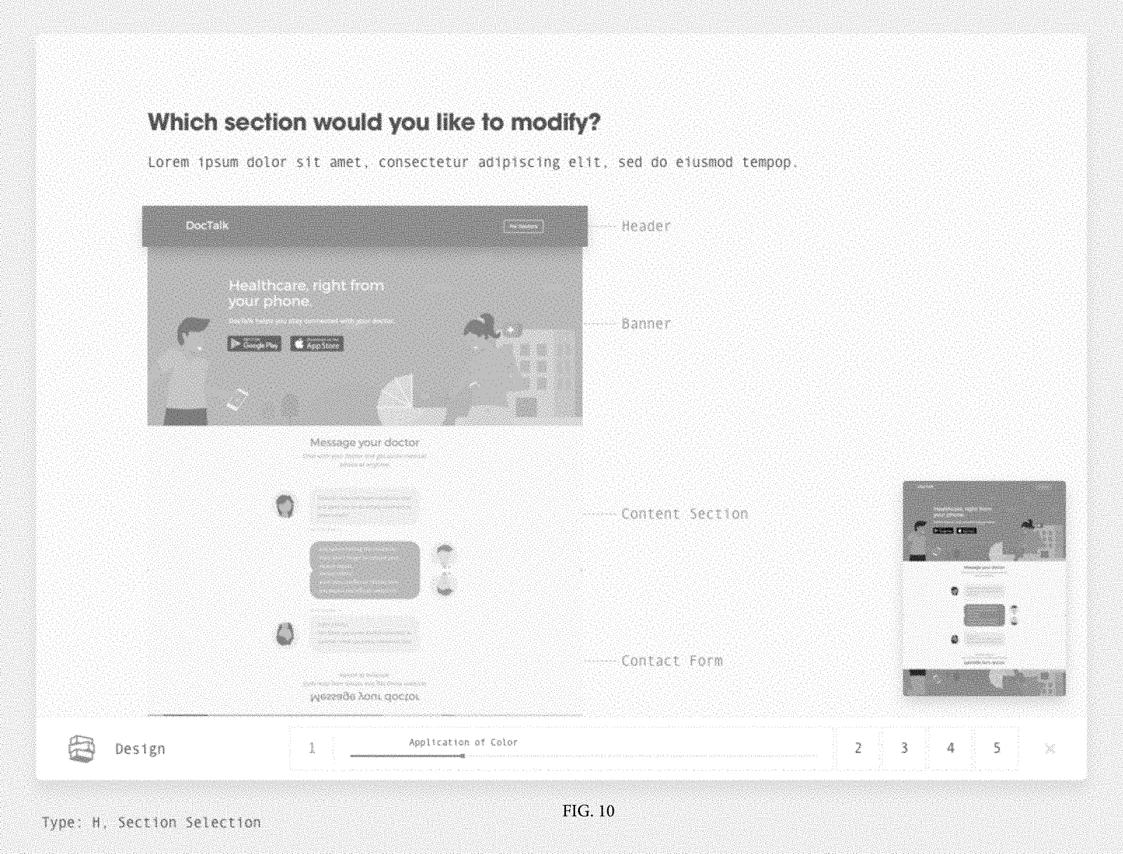

FIG. 10 provides the user with the ability to modify sections of the webpage such as the head, banner, content section and contact form. The user can apply color in various ways to each of these sections of the website.

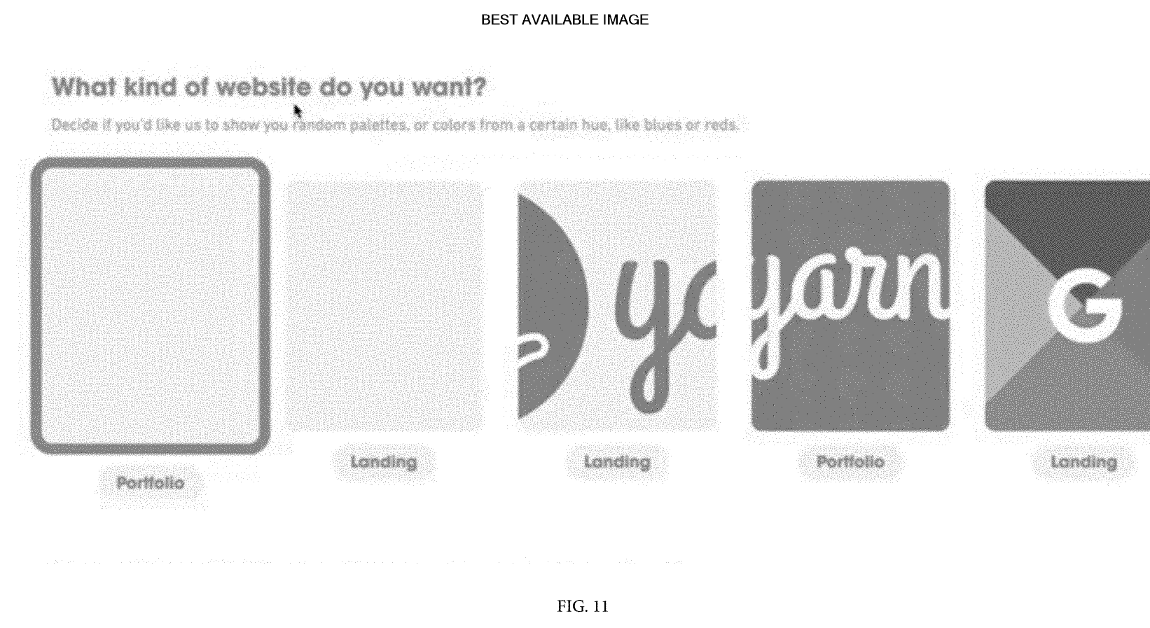

FIGS. 11-13 are screen shots of a questions of an embodiment of the invention and provide a second flow. FIG. 11 asks the user about the type of website desired and uses icons with images that the user can select to pick a type of website. The user can use a joystick or a spacebar to scroll through the options until the user finds the type of website desired.

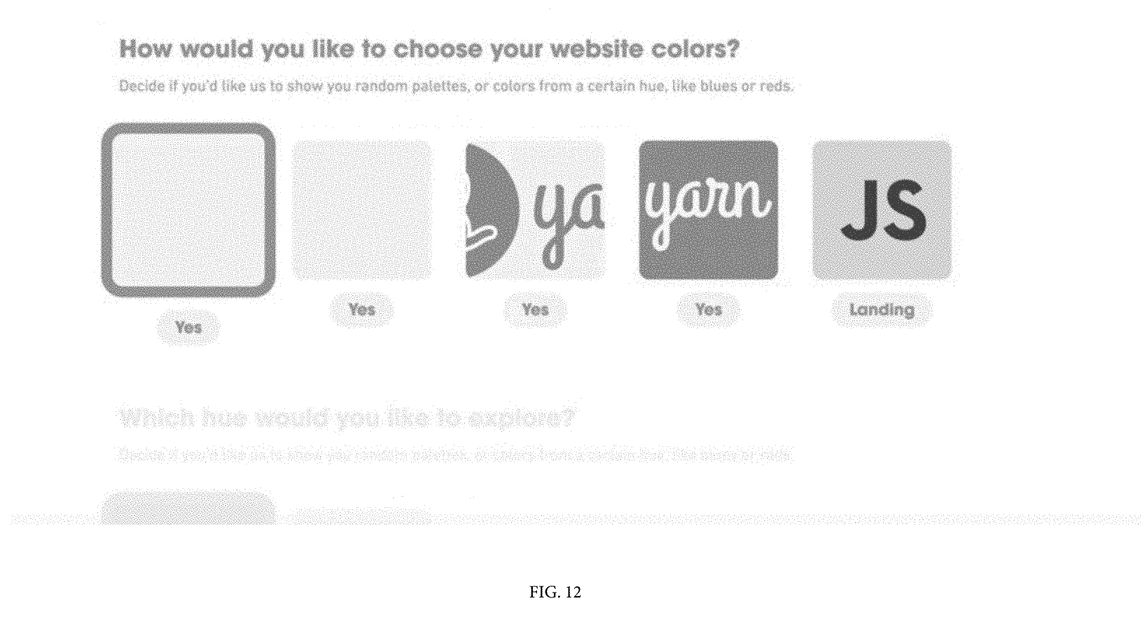

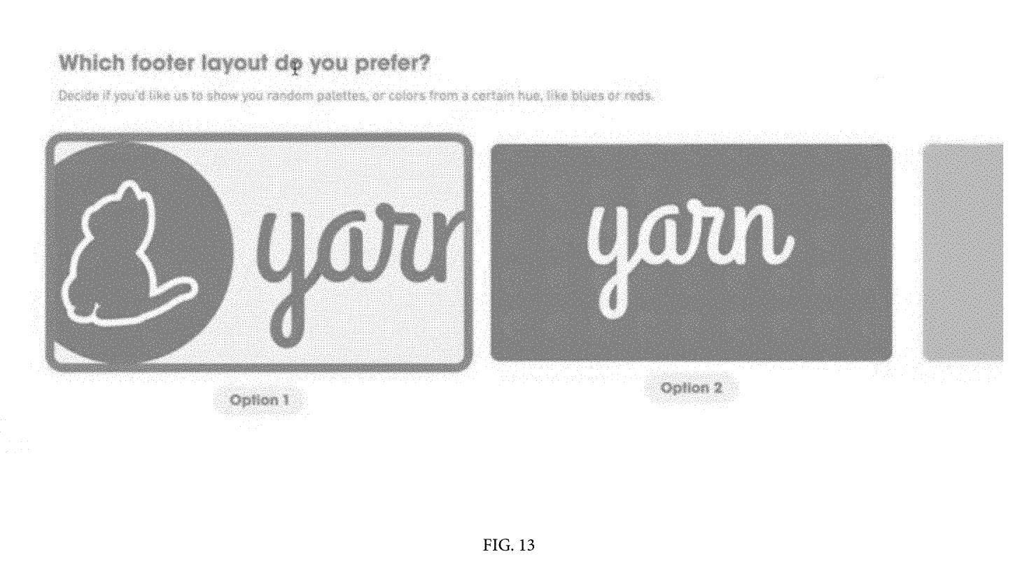

FIG. 12 asks a user how to choose website colors and provides the option of choosing various hues of colors. FIG. 13 asks the user for a type of footer layout to help design the website. In FIGS. 11-13, a flow is provided such that various questions are provided to the user to assist in creation of a design output.

Additional Design Elements

In certain embodiments, design element questions/topics include:
selecting at least one visual representation within a set;
selecting at least one option from a set of options comprised of at least one option, (multiple choice, but the visual object being selected is not the value being input—For example, moving the position of a link or text on a page can't be classified as a selection of a visual representation as much as it would be a selection from multiple options, where the options are positions on a page);
submitting a file, (uploading an image, video, etc.); and
submitting a text value; (hex value for a color, copy, etc.).

Additional embodiments of the invention involve provide a method and system that enables a user to leverage historic website visitor data in offering insights on how to change/alter a websites design, artwork, pages, copy, layout, structure or architecture.

In certain embodiments, the historical website visitor data is used to create questions and add to the question flow in order to create a design output.

In certain embodiments, the method and system suggest changes or automatically change websites based on data (the system automatically decides which design variables to apply based on data vs. only the user deciding). In this embodiment, the color selection is automatic and not manually controlled, or only partially manually controlled.

In certain embodiments, the method and system produce a range of outcomes to improve the design of a website, such as:

1) Actionable list of suggestions on how to change a websites design; and

2) automatically make the change for the website owner.

In certain embodiments, the method and system decide on what variables to go with for a design output based solely on the results of a group survey. In this embodiment, the results from a group survey affect the design output.

In certain embodiments, the method and system automatically applies a new design style and measure well-defined acceptance criteria data when it determines if the automatically applied new design style improves performance of the design output.

In certain embodiments, the method and system work in real-time. In certain embodiments, the method and system do not work in real time.

In certain embodiments, the method and system is used to suggest more than one new design style, whether it's being shown by the system to all website visitors or if a subset of website users are automatically shown one or more variations being tested for performance improvement. In certain embodiments, the system tracks performance metrics of the said variations in determining if one or more design styles improves performance.

In certain embodiments, the method and system include generating a survey with several design options in the form of an independent variable (i.e. a color, a font family, a header layout) or in the form of a showing the resultant application of one or more design options when applied on the web site for visual comparison. The survey could be sent to a website owner's network or focus group or any group comprising one or more individuals soliciting opinions and advice on which design style is preferred.

In certain embodiments, the method and system include a group of individuals collaborating in the same virtual environment in real-time in defining which design variables are chosen by the system in producing a final design output.

In certain embodiments, the method and system include a group of individuals collaborating in a virtual environment across a certain spectrum of time (not in real-time) in defining which design variables are chosen by the system in producing a final design output, such as via a survey or time-based initiative.

In certain embodiments, the method and system include a group of individuals collaborating in the same virtual environment in providing insights for the design output owner in weighting in or providing opinions defining which design variables are chosen by the system in producing a final design output. The responses and inputs of the individuals supporting the design output owner, such as a website owner, and whether the responses of individuals in the group are included in the final design might be up to the discretion of the website owner. The website owner might see which of a variety of options are most favorable to the group and then decide whether or not to select the most favorable.

In certain embodiments, the method and system producing a range of design output types, including but not limited to web sites, blogs, computer software, mobile applications, graphic design, interior designs, architectural designs, flow charts, diagrams, illustrations, icons, brochures, advertisements, print media, digital advertisements, presentations, marketing collateral, contracts, emails, business cards, banners, automotive design, civil engineering designs, electrical designs, fashion design, fashion accessory design, motion design, construction, culinary arts, set design, stage design, and the like.

In certain embodiments, the method and system include automatically generating more than one final design output by selecting one design variable for all required inputs. In certain embodiments, the user can select from one final design output and modify the final outcome by selecting a single design variable to refine the design.

In certain embodiments, the method and system include a user submitting an existing design in the form of an image, software code, a file, a URL, etc. and for the system to analyze and find design elements from the submitted design specimen. From the variables successfully extracted from the submitted design specimen, the system produces one or more design outputs for the preview customization and selection of the end-user creating the new design output. Some variables the system will extract from a submitted design specimen may include but is not limited to colors, color applications, fonts, textures, materials used, image styles, icon styles, illustration styles, layouts, number of pages, architecture, structure of the design, object placement, copy & words, links, button styles, input styles, shapes, and the like.

Computer System & System Architecture

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps in the invention can be performed by a programmable processor execution a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in 50 assembly or machine language if desired; and in any case, the language can be a compiled or interpreted language.

Suitable processors include, by way of example, both general and special purpose microprocessors. Generally, a processor will receive instructions and data from a read-only memory and/or a random-access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and optical disks. Any of the foregoing can be supplemented by, or incorporated in, ASICs (application-specific integrated circuits).

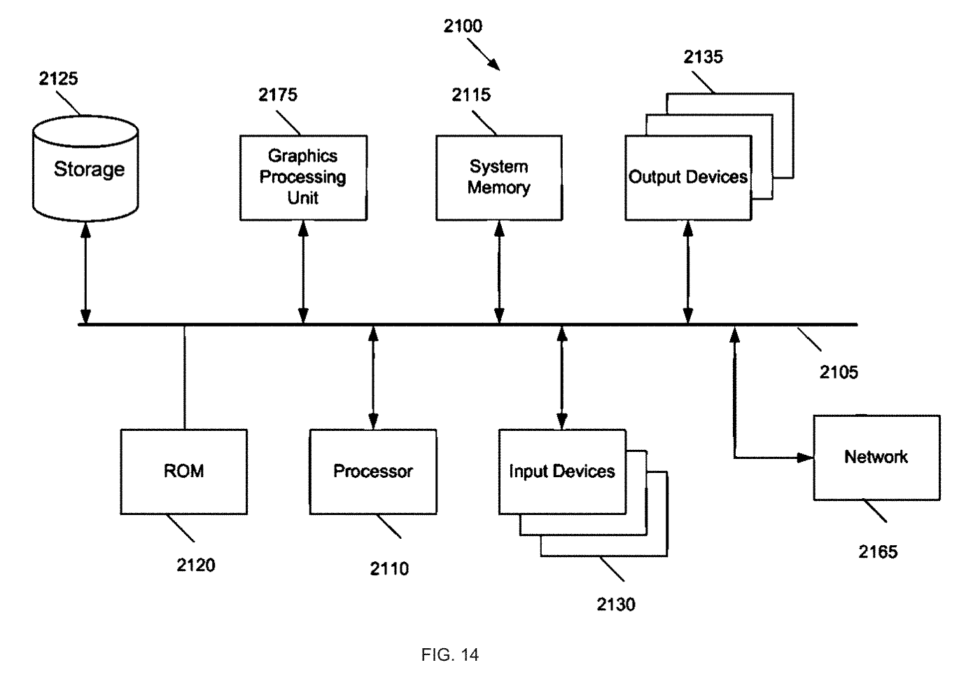

FIG. 14 conceptually illustrates a computer system with which some embodiments of the invention are implemented. The computer system 2100 includes a bus 2105, a processor 2110, a system memory 2115, a read-only memory 2120, a permanent storage device 2125, input devices 2130, and output devices 2135. In some embodiments, the computer system also includes a graphic processing unit (GPU) 2175.

The bus 2105 collectively represents all system, peripheral, and chipset buses that support communication among internal devices of the computer system 2100. For instance, the bus 2105 communicatively connects the processor 2110 with the read-only memory 2120, the system memory 2115, and the permanent storage device 2125.

From these various memory units, the processor 2110 (also referred to as central processing unit or CPU) retrieves instructions to execute and data to process in order to execute the processes of the invention. The read-only-memory (ROM) 2120 stores static data and instructions that are needed by the processor 2110 and other modules of the computer system.

The permanent storage device 2125, on the other hand, is a read-and- write memory device. This device is a non-volatile memory unit that stores instruction and data even when the computer system 2100 is off. Some embodiments of the invention use a mass-storage device (such as a magnetic or optical disk and its corresponding disk drive) as the permanent storage device 2125. The permanent storage device 2125 may be a fully solid-state storage, a conventional “spinning magnetic pallet” storage (i.e. hard-drive), or combinations thereof.

Other embodiments may use a removable storage device (such as a USB flash drive or SD Memory Card) as a temporary storage or as the permanent storage device 2125.

Like the permanent storage device 2125, the system memory 2115 is a read and write memory device. However, unlike storage device 2125, the system memory is a volatile read-and-write memory, such as a random-access memory. The system memory stores at least some of the instructions and data that the processor needs at runtime.

Instructions and/or data needed to perform processes of some embodiments are stored in the system memory 2115, the permanent storage device 2125, the read-only memory 2120, or any combination of the three. For example, the various memory units may contain instructions for processing multimedia items in accordance with some embodiments. From these various memory units, the processor 2110 retrieves instructions to execute and data to process in order to execute the processes of some embodiments.

The bus 2105 also connects to the input and output devices 2130 and 2135. The input devices enable the user to communicate information and select commands to the computer system. The input devices 2130 include alphanumeric keyboards, touch panels, and cursor controllers. The input devices 2130 also include scanners through which an image can be input to the computer system. The output devices 2135 display images generated by the computer system. The output devices may include printers, pen plotters, laser printers, ink-jet plotters, film recorders, and display devices, such as cathode ray tubes (CRT), liquid crystal displays (LCD), or electroluminescent displays.

As shown in FIG. 14, bus 2105 also couples computer 2100 to a network 2165 through a network adapter (not shown). In this manner, the computer can be a part of a network of computers (such as a local area network (“LAN”), a wide area network (“WAN”), or an Intranet) or a network of networks (such as the Internet). Finally, as shown in FIG. 4, the computer system in some embodiments also optionally includes a graphics processing unit (GPU) 2175. A GPU (also referred to as a visual processing unit or a display processor) is a dedicated graphics rendering device which is very efficient in manipulating and displaying computer graphics. The GPU can be included in a video card (not shown) or can be integrated into the mother board of the computer system along with the processor 2110. Also, the computer system 2100 may be used as a personal computer, a workstation, a game console, or the like. Any or all of the components of computer system 2100 may be used in conjunction with the invention. However, one of ordinary skill in the art will appreciate that any other system configuration may also be used in conjunction with the invention.

Having thus described several embodiments for practicing the inventive method, its advantages and objectives can be understood. Variations from the drawings and description can be made by one skilled in the art without departing from the scope of the invention, which is to be determined from the following claims.

Accordingly, this invention is not to be limited by the embodiments as shown in the drawings and/or as described in the description, since these are given by way of example only and not by way of limitation.

What is claimed is:

1. A system for creating a design output using a software program, comprising:
a processor;
a user interface; and
software executing on the processor configured to:
present to and prompt a user to provide an element value to satisfy one or more design element questions or topics;
determine whether the one or more design element questions or topics are satisfied by the element value;
visually display the result of the element value of a question or topic in real-time to the user on said interface; and
produce a design output,
wherein the design output is produced upon the satisfaction of at least one design element question or topic by the element value in a finite set of at least one questions or topics.

2. The system of claim 1, wherein the design output is produced in accordance with all design element values satisfied for the design element questions or topics in the set of questions or topics.

3. The system of claim 1, wherein the result of the element value of a question or topic is displayed before, during and after determining the one or more design element questions or topics are satisfied by the element value.

4. The system of claim 1 wherein the one or more design element questions or topics are selected from a group consisting of: at least one visual representation within a set of visual representations; at least one option from a set of options comprised of at least one option; a file; and a text value.

5. The system of claim 4, wherein based at least in part upon the user selecting at least one visual representation within the set, the software executing on the processor presents to the user a second set of at least one visual representations for selection.

6. The system of claim 1 wherein the at least one question or topic is a color, a shape, a font, and image, a video and a sound, and a combination thereof.

7. The system of claim 1 wherein the at least one question or topic is configured to control a mathematical function, hyperlink, executable application, or a combination thereof.

8. The system of claim 1 wherein the software provides a series of questions or topics relating to color palettes, color application in a specimen, color flows, font preferences, image style preferences, icon style preferences, illustration style preferences and a combination thereof.

9. The system of claim 1, wherein the design output is generated in real-time.

10. The system of claim 1, wherein the interface is manipulated using a toggle control or a selector control.

11. The system of claim 6, wherein the toggle control includes a right down arrow key, space bar, 4-way joystick.

12. The system of claim 1, wherein the interface is hosted via a server or on a website.

13. The system of claim 1, wherein the design output is code for a website.

14. The system of claim 1, wherein the design output is code for an email, a mobile homepage, a pitch deck and social ad and a software dashboard, and combinations thereof.

15. The system of claim 1, wherein the design output is generated based on rules using custom generated design preferences.

16. The system of claim 1, wherein the design output is not based upon pre- existing templates or previously established design styles.

17. The system of claim 1, wherein the system is dynamic and wherein there are different sets of element values presented to the user depending upon the previous element values selected by the user.

18. The system of claim 1, wherein the design output is a software code output.

19. A method for creating a design output using a software program, the method comprising the steps of:
providing a software executing on a processor, the software performing the following steps:
presenting to and prompting a user to provide an element value to satisfy one or more design element questions or topics;
determining whether the one or more design element questions or topics are satisfied by the element value;
visually displaying the result of the element value of a question or topic in real-time to the user before, during and after determining the one or more design element questions or topics are satisfied by the element value;
producing a design output upon the satisfaction of at least one design element question or topic by the element value in a finite set of at least one questions or topics.

20. The method of claim 18, wherein the design output is a software code output.

21. A non-transitory computer readable storage medium storing a computer program product for selecting design elements for a software program, the non- transitory computer readable storage medium comprising:
computer executable instructions and data, the computer executable instructions able to execute a computer program able to:
present to and prompt a user to provide an element value to satisfy one or more design element questions or topics;
determine whether the one or more design element questions or topics are satisfied by the element value;
visually display the result of the element value of a question or topic in real-time to the user before, during and after determining the one or more design element questions or topics are satisfied by the element value;
produce a design output upon the satisfaction of at least one design element question or topic by the element value in a finite set of at least one questions or topics.

22. The non-transitory computer readable storage medium of claim 20, wherein the design output is a software code output.
